(19) United States
(12) Patent Application Publication
(10) Pub. No.: US 2005/0288898 A1
(43) Pub. Date: Dec. 29, 2005

(54) Systems and methods for analyzing machine failure

(76) Inventor: Canh Le, San Jose, CA (US)

Correspondence Address: TRAN & ASSOCIATES, 6768 MEADOW VISTA CT., SAN JOSE, CA, 95135, US

(21) Appl. No.: 10/867,905

(22) Filed: Jun. 14, 2004

(51) Int. Cl. G06F 11/30; G06F 15/00; G21C 17/00

(52) U.S. Cl. 702/183

(57) ABSTRACT

Systems and methods are disclosed for analyzing machine operational characteristic by digitizing an electrical parameter associated with a motor; applying a transform operation to the electrical parameter of the motor; and determining failure based on the transform operation.

### BACKGROUND

The present invention relates to systems and methods for machine fault analysis.

In the manufacture of semiconductors, such as integrated circuits (ICs), dynamic random access memories (DRAMs), etc., large thin wafers (typically of silicon) from which the semiconductors are fabricated must frequently be transferred from one processing chamber to another. This transfer of wafers must be carried out under conditions of absolute cleanliness and often at sub-atmospheric pressures. To this end various mechanical arrangements have been devised for transferring wafers to and from processing chambers in a piece of equipment or from one piece of equipment to another.

As noted in U.S. Pat. No. 6,582,175, it is the usual practice to load wafers into a cassette so that a number of them can be carried under clean-room conditions safely and efficiently from one place to another. A cassette loaded with wafers is then inserted into an input/output (I/O) chamber (“load lock” chamber) where a desired gas pressure and atmosphere can be established. The wafers are fed one-by-one to or from their respective cassettes into or out of the I/O chamber. It is desirable from the standpoint of efficiency in handling of the wafers that the I/O chamber be located in close proximity to a number of processing chambers to permit more than one wafer to be processed nearby and at the same time. To this end two or more chambers are arranged at locations on the periphery of a transfer chamber which is hermetically sealable and which communicates with both the I/O chamber and the processing chambers. Located within the transfer chamber is an automatically controlled wafer handling mechanism, or robot, which takes, wafers supplied from the I/O chamber and then transfers each wafer into a selected processing chamber. After processing in one chamber a wafer is withdrawn from it by the robot and inserted into another processing chamber, or returned to the I/O chamber and ultimately a respective cassette.

Semiconductor wafers are by their nature fragile and easily chipped or scratched. Therefore they are handled with great care to prevent damage. The robot mechanism which handles a wafer holds it securely, yet without scratching a surface or chipping an edge of the brittle wafers. The robot moves the wafer smoothly without vibration or sudden stops or jerks. Vibration of the robot can cause abrasion between a robot blade holding a wafer and a surface of the wafer. The “dust” or abraded particles of the wafer caused by such vibration can in turn cause surface contamination of other wafers, an undesirable condition. As a result the design of a robot requires careful measures to insure that the movable parts of the robot operate smoothly without lost motion or play, with the requisite gentleness in holding a wafer, yet be able to move the wafer quickly and accurately between locations.

Wafer handler robots commonly use motors, pulleys, and belt as major drive train components to actuate movements. Belt drives generally include a belt entrained between two or more pulleys. The belt generally operates at a predetermined operating tension. To achieve a predetermined operating tension, a belt may be installed about the pulleys in a slack condition. A center of one or more pulleys is then moved, thereby introducing the desired tension into the belt.

Since the motor/belt/pulley are mechanical devices, they are subject to stress and eventual failure. As noted in U.S. Pat. No. 6,735,549, many industries have experienced an increased awareness of and emphasis on the benefits and use of predictive maintenance technologies. Use of such technologies has the potential to improve the long-term availability and reliability of plant components resulting in an overall improvement to plant operability.

### SUMMARY

In one aspect, a method for analyzing machine operational characteristic includes digitizing an electrical parameter associated with a motor; applying a transform operation to the electrical parameter of the motor; and determining failure based on the transform operation.

Implementations of the above method may include one or more of the following. The method can be used to maintain a semiconductor processing system based on the transform operation. The motor can drive a first pulley with a first belt. A second pulley can be driven using a second belt between the first and second pulleys. The distance between two pulleys can be adjusted based on a belt tension. The transform parameter can be compared with a known-good-value. An error can be logged if the transform parameter is below the known-good-value. The known-good-value can be an amplitude of the transform parameter. Known-good-values can be collected before the system operates in real-time (live operation). The transform operation can be a Discrete Fourier Transform (DFT). The method includes measuring current drawn by the motor while actuating connected belts and pulleys. The electrical parameters relate to friction characteristics of drive train components or characteristic signature of each individual component. Electrical parameter data can be collected over a period of time for historical analysis.

In another aspect, a system for determining machine performance includes means for digitizing an electrical parameter associated with a motor; means for applying a transform operation to the electrical parameter of the motor; and means for determining performance based on the DCT operation.

In yet another aspect, an apparatus for analyzing component operation includes an analog to digital converter (ADC) coupled to a component to capture a characteristic signature of the component; a transform processor coupled to the ADC to characterize component performance as a function of the frequency; and a user interface to display component operation analysis.

Advantages of the system may include one or more of the following. The system provides predictive maintenance technologies. Use of such technologies has the potential to improve the long-term availability and reliability of components resulting in an overall improvement to operability. The predicted failures can be based on time remaining to failure, depicted in terms of the future point in time in which the failure will likely occur along with a corresponding confidence interval. The system allows personnel to explore various maintenance scheduling alternatives, by determining what the specific probability of equipment failure will be for any future point in time.

### BRIEF DESCRIPTION OF THE DRAWINGS

The invention will be more fully understood from the description of the preferred embodiment with reference to the accompanying drawings, in which:

FIG. 1 shows a block diagram of an exemplary test system.

FIG. 2 shows a drive train assembly

FIG. 3 shows a composite signal of motor's current actuating drive-train movements

FIG. 4 shows a DFT analysis of the individual motor's current signal.

FIG. 5 shows a DFT analysis of a first pulley signal.

FIG. 6 shows a DFT analysis of a second pulley signal.

FIG. 7 shows a DFT analysis of a third pulley signal.

FIG. 8A-8B show one embodiment for automatically detecting or predicting pulley/belt failures.

### DESCRIPTION

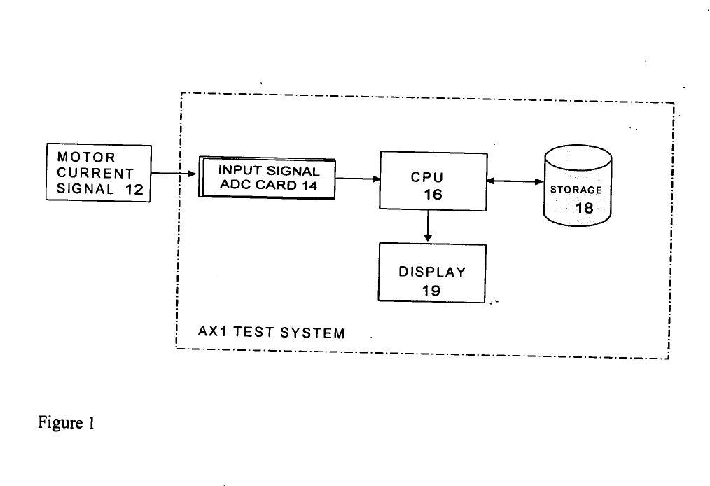

FIG. 1 shows a block diagram of an exemplary test system. A drive train is used with one motor driving one or more pulleys using transmission belts. Electrical current is applied to the motor which actuate the pulleys movements using the connected belts. However, over time natural wear and tear can catastrophically cause un-predicted failures. To detect potential failures, the motor is characterized by the amount of current it consumes.

In FIG. 1, the electrical power applied to a motor 10 is sensed. In this embodiment, a motor current signal 12 is provided to a digitizer such as an analog to digital converter 14. Instead of current, alternatives such as voltage can be sensed as well.

The output of the ADC 14 is provided to a processor 16. The processor 16 in turn processes data and stores data in a data storage device 18. The processor also displays result to the user using a display 19.

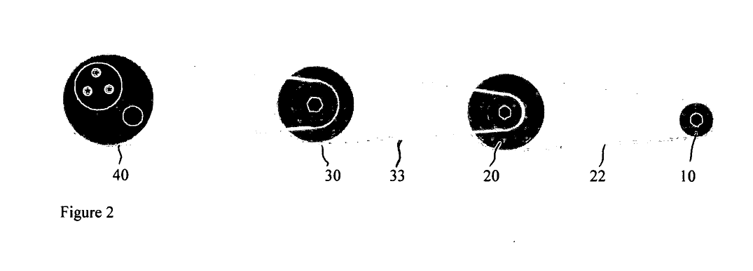

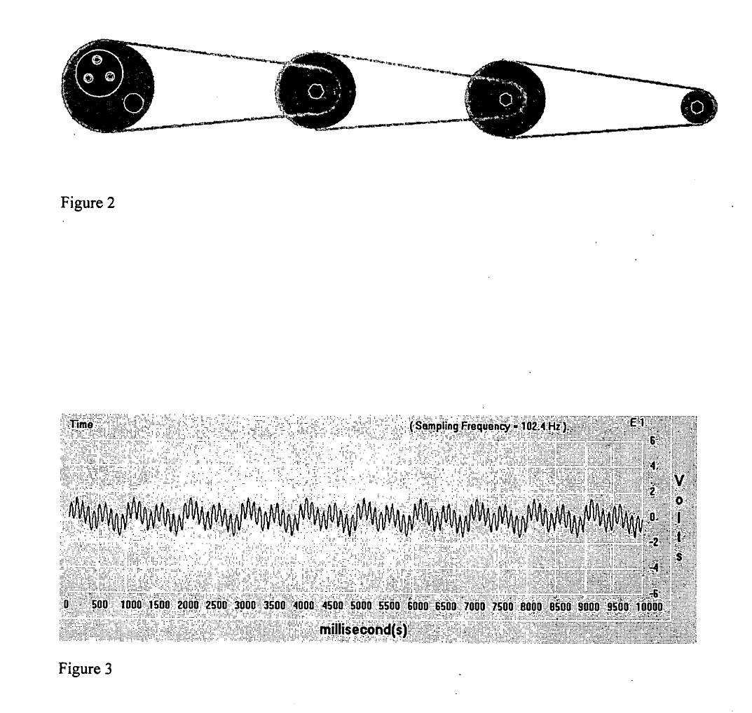

FIG. 2 shows an exemplary drive train assembly, in this example an assembly with three pulleys 20, 30 and 40. In FIG. 2, the motor 10 spins and drives the first pulley 20 with a first belt 22, which in turn drives the second pulley 30 with a second belt 33, which in turn drives a third pulley 40. The belt tension may be adjusted using a belt tensioner. The purpose of a belt tensioner is to maintain a substantially constant tension in a drive belt. In most applications, the belt connects stationary pulleys. Hence, belt tension can be set by affixing one pulley to a mount having an adjustable linkage to a fixed mounting surface. Automobile engine belts are common examples of this type of system.

In typical power transmission arrangements, a belt is spanned over and around one or more pulleys. Conventionally, to measure a tension of the belt, the belt is pushed downwardly under a predetermined pressure applied by means of a pressure gauge (or manometer) disposed so as to bear against the belt at a predetermined position thereof, whereby the belt is deflected downwardly by a predetermined distance or deflection. The pressure applied to the belt at that time point is measured by using the pressure gauge itself. Mechanical devices for measuring drive belt tension thus are purely mechanical and clamp on to a short section of the belt and predict tension either by applying a known force and measuring belt deflection, or by applying a known deflection and measuring force. Alternatively, the apparatus disclosed in commonly owned, co-pending application Ser. No. 10/______ entitled “SYSTEMS AND METHODS FOR MEASURING BELT TENSION”, the content of which is incorporated by reference, can be used.

FIG. 3 shows a composite signal of motor's current actuating drive train movements. In this example, a number of signals contribute to a periodic pattern that is difficult to characterize. To better understand the data, a Discrete Fourier Transform (DFT) is applied to convert current values into a spectrum. DFT is used to identify the regular contributions to a fluctuating signal, thereby helping to make sense of observations the motor current consumption. The Fourier transform is the mathematical tool used to make this conversion. Simply stated, the Fourier transform converts waveform data in the time domain into the frequency domain. The Fourier transform accomplishes this by breaking down the original time-based waveform into a series of sinusoidal terms, each with a unique magnitude, frequency, and phase. This process, in effect, converts a waveform in the time domain that is difficult to describe mathematically into a more manageable series of sinusoidal functions that when added together, exactly reproduce the original waveform. Plotting the amplitude of each sinusoidal term versus its frequency creates a power spectrum, which is the response of the original waveform in the frequency domain.

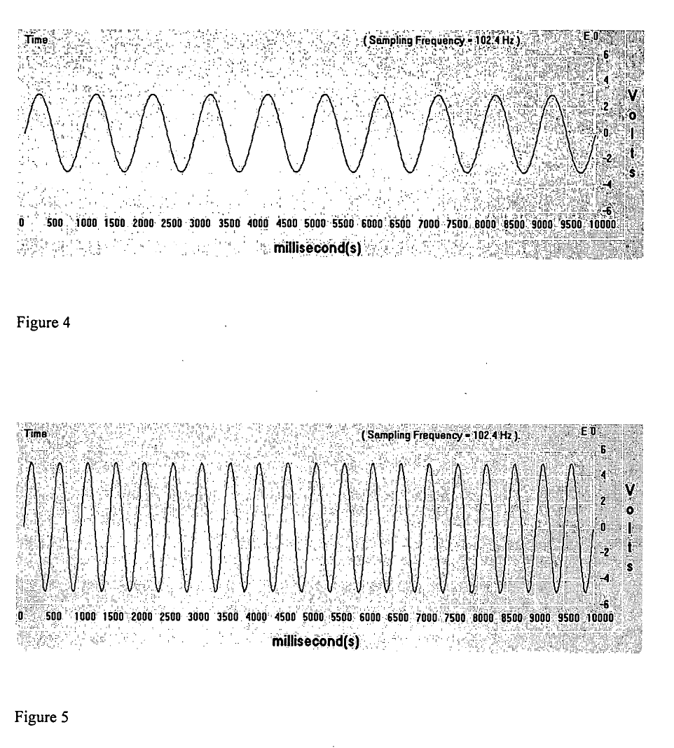

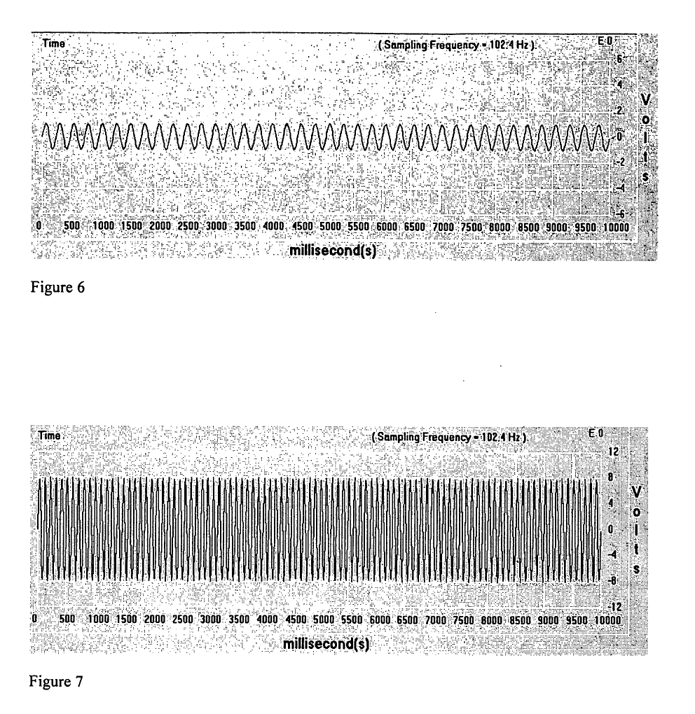

FIG. 4 shows a DFT analysis of an exemplary motor's current signal. In this example of a system that is operating within specification, the amplitude is about six volts and repeats proximally every second (1 Hz). FIG. 5 shows a DFT analysis of a first pulley signal which is sinusoidal with amplitude of about 10V. FIG. 6 shows a DFT analysis of a second pulley signal, while FIG. 7 shows a DFT analysis of a third pulley signal. FIGS. 4-7 show periodic signals that are sinusoidal and highly repeatable. These data points are characterized for subsequent comparison to determine whether a particular system is operating outside of the desired specification.

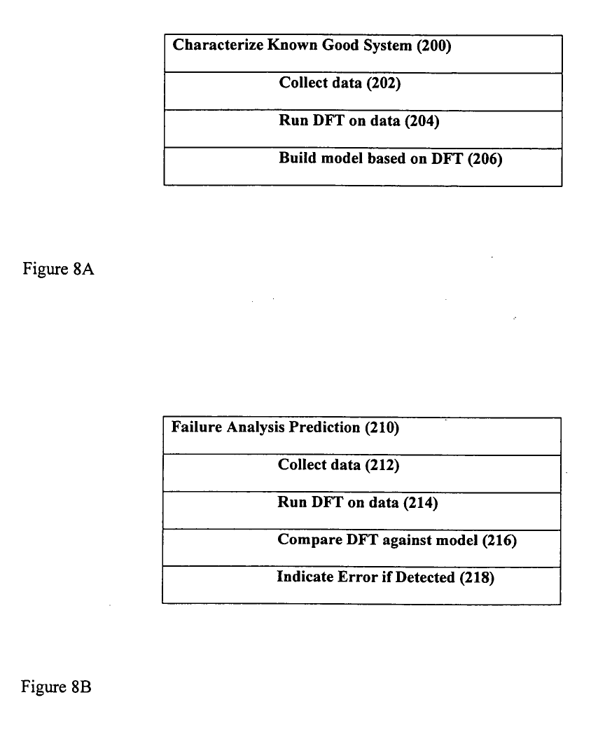

FIG. 8A-8B show one embodiment for automatically detecting or predicting pulley/belt failures. The system has two modes of operation. The first mode is a training mode where the system characterizes a Known Good System (200). The second mode is an operating mode where the system performs Failure Analysis Prediction (210).

Turning now to FIG. 8A, during training, the system collects data from a known good system (202). In this embodiment, current data from the motor is collected. Next, the system runs DFT on data (204), and a model is built based on DFT (206). In one implementation, the model can be:
IF DFT AMPLITUDE OF PULLEY 1<VALUE 1, THEN SET ERROR FLAG
IF DFT AMPLITUDE OF PULLEY 2<VALUE 2, THEN SET ERROR FLAG
IF DFT AMPLITUDE OF PULLEY 3<VALUE 3, THEN SET ERROR FLAG

In FIG. 8B, the system performs Failure Analysis Prediction (210). The failure analysis/prediction can be done on-the-fly (in real-time) or can be done non-real-time. As before, the process collects data during operation (212). Next, the process applies the DFT on data (214). The result of the DFT is compared against model (216) and an Error can be flagged if detected (218). For example, if the amplitude of pulley 1 is below the predetermined threshold of VALUE 1, then an error is logged so that repair can be effected for pulley 1. Similarly, pulleys 2 and 3 can be monitored for potential failure.

Although the above example shows checking against predetermined values, the system can check against predetermined patterns as well. In such embodiments, the system uses a number of learning algorithms including neural networks, statistical modelers, fuzzy logic, and expert systems to analyze and predict failure.

For example, trend analysis can used to assess equipment health and degradation by monitoring for changes in selected measurement parameters over time. The trended information may be in either the original time domain or in the frequency DFT domain. To perform trend analysis, parameters to be trended are first identified, the trend periodicity to be utilized is then defined, and alert/warning criteria for early identification of impending problems are finally developed. Typically, the equipment manufacturers' recommendations and industry experience are used to develop alert/alarm criteria. Statistical methods are utilized to enhance the trend accuracy. Alternatively, Pattern Recognition techniques are utilized to assess equipment health and degradation by analyzing the selected measurement parameters relative to state or status patterns. Statistical methods are used to improve pattern recognition accuracy. Techniques such as Time Source Analysis and Fast Fourier Transform are typically used to process the data in conjunction with pattern recognition algorithms. In another alternative, Correlation Techniques can be used. Related sets of data may be correlated to assist in performing predictive analysis. Correlation coefficients are developed to aid in the recognition of patterns or the recognition of sequences of events that are related. Component monitoring may utilize alarm/alert limits using thresholds, bands and frequency filters. This approach allows subsequently gathered information to be compared to expected regions of operation for the monitored components. Several comparative methods may be utilized for preventative maintenance data analyses. Data for a particular system or component can be compared to standard values, manufacturers' recommendations, technical specifications, code limits, or normal baseline data or ranges. Data may be compared on an absolute basis or a relative basis. As an example, data from a specific component may be analyzed to identify discontinuities (breaks) in a performance curve, or data trends, or data offsets. In addition, data on similar components can be compared to develop comparison data relative to similar components. This comparison of data is used to assess equipment or system health and aging. Statistical Process Analysis can also be applied. Techniques, such as curve fitting, data smoothing, predictive techniques and probabilistic inference techniques (such as Bayesian Belief Networks), and mean standard deviation can be used.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

1. A method for analyzing machine operational characteristic, comprising:
digitizing an electrical parameter associated with a motor;
measuring current drawn by the motor while actuating connected belts and pulleys;
applying a frequency transform operation to the electrical parameter of the motor; and
determining failure based on the transform operation.

2. The method of claim 1, further comprising maintaining a semiconductor processing system based on the transform operation.

3. The method of claim 1, wherein the motor drives a first pulley with a first belt.

4. The method of claim 1, comprising driving a second pulley with a second belt between the first and second pulleys.

5. The method of claim 4, comprising adjusting a distance between two pulleys based on a belt tension.

6. The method of claim 1, comprising comparing the transform parameter with a known-good-value.

7. The method of claim 6, further comprising indicating an error if the transform parameter is below the known-good-value.

8. The method of claim 7, wherein the known-good-value is an amplitude of the transform parameter.

9. The method of claim 6, comprising collecting known-good-values before live operation.

10. The method of claim 1, wherein the transform operation is a Discrete Fourier Transform (DFT).

11. (canceled)

12. The method of claim 1, wherein the electrical parameters relate to friction characteristics of drive train components.

13. The method of claim 1, wherein the electrical parameters relate to a characteristic signature of each individual component.

14. The method of claim 1, comprising collecting electrical parameter data over a period of time.

15. A system for determining machine performance, comprising:
means for digitizing an electrical parameter associated with a motor;
means for measuring current drawn by the motor while actuating connected belts and pulleys;
means for applying a transform operation to the electrical parameter of the motor; and
means for determining performance based on the a DCT operation.

16. The method of claim 15, wherein the transform operation is a Discrete Fourier Transform (DFT).

17. The method of claim 15, comprising means for measuring current drawn by the motor while actuating connected belts and pulleys.

18. An apparatus for analyzing component operation, comprising:
an analog to digital converter (ADC) coupled to a component to capture a characteristic signature of the component;
a current sensor to measure current drawn by the motor while actuating connected belts and pulleys;
a transform processor coupled to the ADC to characterize component performance as a function of the frequency; and
a user interface to display component operation analysis.

19. The apparatus of claim 18, wherein the component drives a first pulley, further comprising a belt mounted between a first pulley and a second pulley.

20. The apparatus of claim 19, wherein the belt tension is adjusted based on the component performance.
